(19) United States
(12) Patent Application Publication
(10) Pub. No.: US 2011/0174717 A1
(43) Pub. Date: Jul. 21, 2011

(54) FILTER DEVICE

(76) Inventors: Michael Braunheim, Goppingen (DE); Matthias Gänswein, Esslingen (DE); Jörg Hrodek, Mittlem (AT); Sven Siegle, Winnenden (DE); Richard Wlassa, Stuttgart (DE); Nelly Klingspon, Winnenden (DE)

(21) Appl. No.: 13/055,849

(22) PCT Filed: Jul. 17, 2009
(86) PCT No.: PCT/EP2009/059241

§ 371 Date: Apr. 8, 2011

(30) Foreign Application Priority Data
Jul. 26, 2008 (DE) 10 2008 034 903.8

(51) Int. Cl. B01D 29/56; B01D 35/30; B01D 36/00

(52) U.S. Cl. 210/251; 210/435; 210/295

(57) ABSTRACT

A filter device having a liquid inlet, a liquid outlet, a filter housing, and at least one filter element. At least one water collection chamber is configured to collect water separated out of the fuel. A mechanism for suppressing biological activity is disposed in at least the water collection chamber.

The present invention relates to a filter device according to the preamble of Claim 1. The invention also relates to an internal combustion engine equipped such such a filter device and a motor vehicle equipped with such an internal combustion engine.

WO 2007/128599 discloses a transportable liquid filter for use after natural disasters, which is used to treat highly contaminated water in such a manner that it can be used as drinking water. The dirty water is cleaned in a plurality of filtration stages, where chemicals are adsorbed, suspended particles and heavy metals are filtered out, and any form of biological activity such as viruses, worms, bacteria, fungi and protozoans are killed, among other things. This liquid filter is however too complex to be used in a motor vehicle, especially as fuels are not necessarily so highly contaminated and the drained water does not necessarily have to be of drinking water quality.

EP 1 581 736 and DE 10 2006 039 581 disclose fuel filters in which a further filter is attached to the filter housing in order to clean the drained water. A disadvantage of this fuel filter type is however that they have a relatively large water collection chamber for the water separated out of the fuel, and therefore, if the fuel is contaminated with bacteria, fungi or others, provide a large volume of water in which biological activity can develop and multiply, and thus form an activated sludge which on the one hand can prevent further flow of fuel, as it forms on the clean side, and may clog the fuel filter, and on the other hand can contaminate the water to be drained and the downstream filter for cleaning the water.

The object of the present invention is to improve a known fuel filter in such a manner that water separated out of the fuel has a higher quality.

This problem is solved according to the invention by the subject matter of the independent claims. Advantageous embodiments form the subject matter of the dependent claims.

The invention is based on the general idea of providing, in a filter device, in particular in a fuel/lubricant filter, with at least one water collection chamber for collecting water separated out of the fuel/lubricant, means for suppressing biological activity and thereby treating the separated water and improving the quality thereof. The filter device has a liquid inlet, a liquid outlet, a filter housing, a replaceable filter element and an above-mentioned water collection chamber, wherein above-mentioned means for suppressing biological activity are present in the said water collection chamber, which means can be configured in such a manner that they have an antibacterial, fungicidal and/or antibiotic effect.

A filter device is also claimed, in which the means for suppressing biological activity contain metals, in particular silver and/or monomers or oligomers with a functional ammonium group. A mini UV LED can also be provided, which has a biocidal effect together with a catalytically active surface. Alternatively, a paint with a signal effect, as is known in shipbuilding, can be provided on the relevant surfaces. Alternatively, a slight AC voltage prevailing in the fuel filter can prevent the growth of micro-organisms.

These measures prevent the formation of activated sludge in the water reservoir. To prevent the filter from being contaminated via the water outlet, the water outlet can also contain biocidal materials or the active carbon filter can be doped with copper or silver ions.

In an advantageous development of the invention, a fibre-based carrier material is provided, which is formed for example as a nonwoven or knitted fabric or as a carpet, and to which the means are applied by suitable coating methods. The means for suppressing the biological activity can alternatively be applied by suitable coating methods to a structured face owing to the increased surface area.

Further important features and advantages of the invention can be found in the subclaims, the drawings and the associated description of the figures using the drawings.

It is self-evident that the features which are mentioned above and those which are still to be explained below can be used not only in the combination specified in each case, but also in other combinations or alone without departing from the scope of the present invention.

Preferred exemplary embodiments of the invention are shown in the drawings and are explained in more detail in the following description, with the same reference symbols referring to the same or similar or functionally identical components.

In the figures,

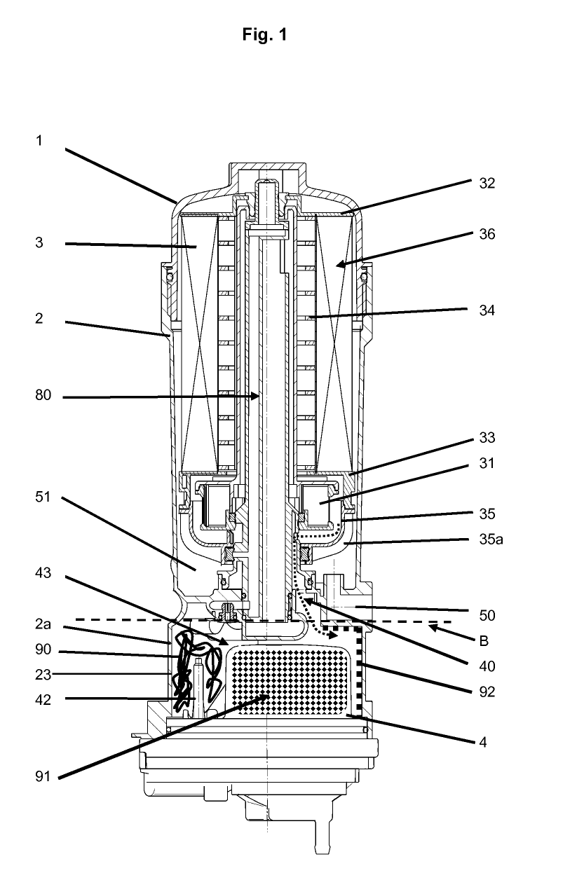

FIG. 1 schematically shows a longitudinal section through a filter device according to the invention,

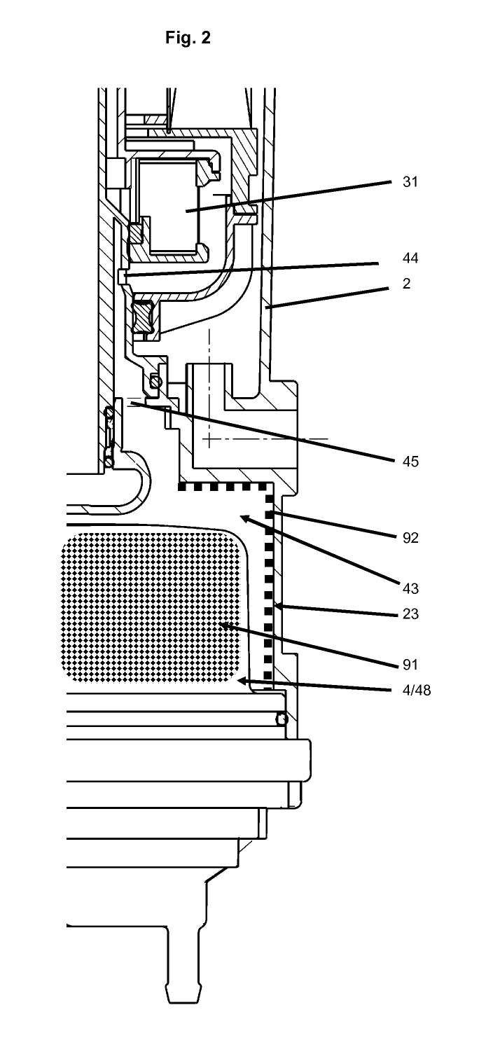

FIG. 2 schematically shows a detail of FIG. 1,

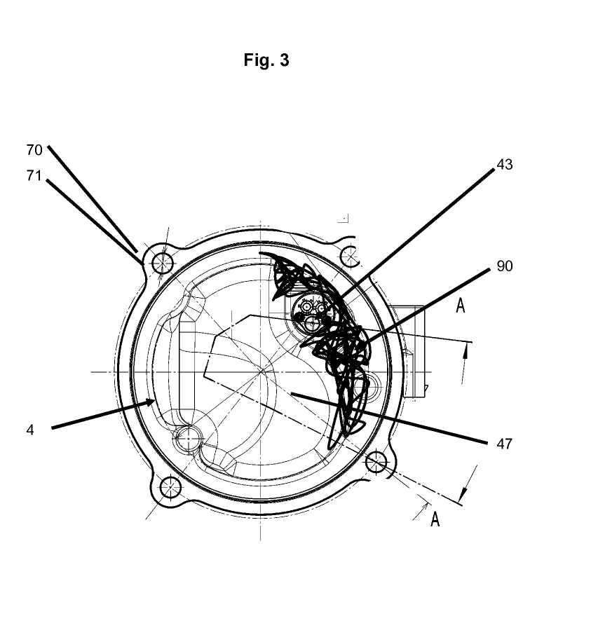

FIG. 3 schematically shows a plan view of a module insert,

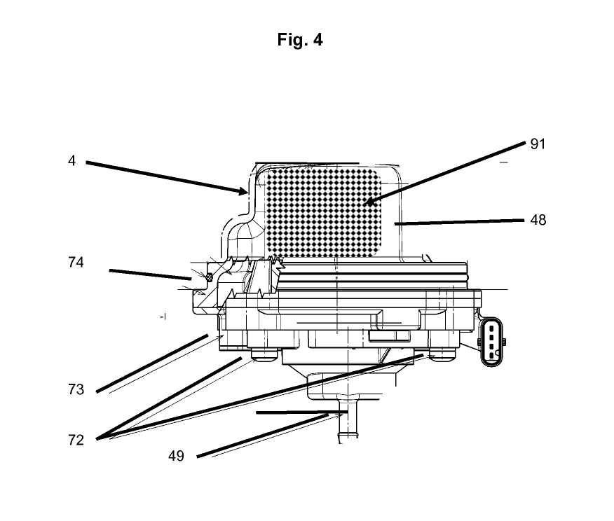

FIG. 4 schematically shows a side view with the module insert cut away,

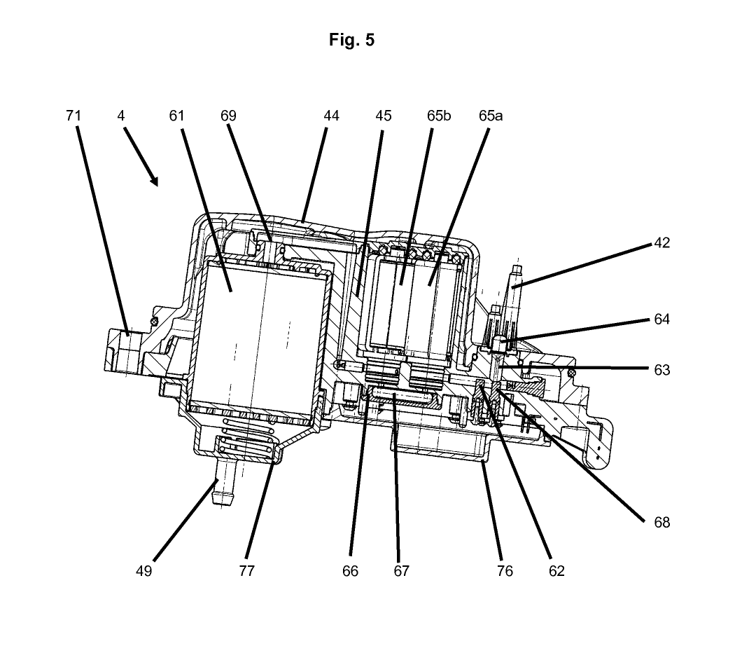

FIG. 5 schematically shows a sectional illustration along line A-A of FIG. 3 of the module insert.

FIG. 1 shows the filter device according to the invention in longitudinal section, which device is in this case configured as a fuel filter. A filter housing 2, which accommodates both a filter element 3 and a module insert 4, can be closed from above with a lid 1. Under this there is a fuel distribution chamber 51 which communicates with an inlet 50. There is also a preseparation means for larger particles, which is not shown here.

The filter element 3 has a cylindrical inner case 34, on which a special paper can sit as the filter 36, and an upper end disc 32 and a lower end disc 33, a base 35 with outer ribs 35a, and a basket-shaped screen 31. When the fuel filter is assembled, the replaceable filter element 3 is pushed over a functional carrier 80, which is fixed in the filter housing 2 and conducts the media water and fuel. The filter element 3 can contain fine-pore special paper or other materials as the filter 36, so that even here the water present in the fuel coalesces and can be separated off. It then flows as tiny droplets with the fuel to the screen 31. The fuel passes through this screen 31 to the clean side and exits the fuel filter via the functional carrier 80 and corresponding outlets (not shown). The basket-shaped screen 31 is made from a lipophilic material in such a manner that the already present water droplets enlarge further and are then transported by gravity downwards into a water collection chamber 43. Suspended matter contained in the fuel is filtered out by the filter element 3. As a little fuel is almost always attached to suspended matter which passes into the water to be separated out, there is less suspended matter in the fuel and thus also less suspended matter in the water separated out if the water is removed from the fuel downstream of the filter element 3. It is therefore advantageous in order to obtain the cleanest possible water to separate out the water on the clean side of the filter element 3. The module insert 4 is inserted from below into the filter housing 2 in the water collection chamber 43 and screwed fast or otherwise fixed.

The path of the water is shown as a dashed arrow 40. The inlet for the fuel is labelled with reference symbol 50; from here the fuel passes into the fuel distribution chamber 51 and the fuel is pushed through the filter element 3 by the high pressure of approximately 5-10 bar in the fuel system. These high pressures with pressure peaks of over 20 bar are also present in the water collection chamber 43. As the interior of the module insert 4 is however not pressure-stable, it is protected by a pressure-stable housing 44. A water level sensor 42 in the water collection chamber 43 ensures that if the water reaches a predefined height it is drained into the module insert 4. The water collection chamber 43 is situated in the filter housing 2 under the dashed line B. The surface of an inner wall 23 of the part 2a of the filter housing 2 can be specially coated on the side facing the water collection chamber 43 in order to suppress biological activity of any kind. Alternatively, the surface of the inner wall 23 can contain small projections/indentations/structures 92 which are coated in the same manner. The shape of the structures 92 can be selected as desired; it can be introduced during the production process or else afterwards. As the filter housing 2 can consist of aluminium or flame-resistant plastic, the type of coating method depends on the type of filter housing material. It can be a CVD (chemical vapour deposition) or plasma coating or simply a paint. Silver is preferably selected to suppress the biological activity, but other substances such as other metals or monomers or oligomers with a functional ammonium group can also be used. These substances do not necessarily have to be tolerated by humans as they are used in the fuel filter and do not have to be used for drinking water. Copper should not be used in the region where it comes into contact with the fuel itself, as it can decompose the fuel and then disrupt the operation of the engine. Other metals must also be safe for the fuel used in this respect.

It is however simpler to place a material in the water collection chamber 43 in order to suppress the biological activity in the collected water. This is shown in FIG. 1. A loose nonwoven fabric 90 consisting of metal fibres or plastic fibres which themselves suppress the biological activity or are coated with a substance which likewise suppresses the biological activity. The same substances can be used here as in the coating of the inner wall 23 of the part 23a of the filter housing 2. Alternatively, a knitted fabric or a type of carpet consisting of these fibres which suppress the biological activity can be used. Although pure silver fibres would be optimal with respect to the property of suppressing the biological activity, they are very expensive, therefore it is more sensible to use silver-coated, fuel-stable plastic fibres. The silver only takes effect on contact with water, that is, only when a minimum quantity of water is separated out of the fuel. Silver ions are then produced which suppress the biological activity.

A further possibility of suppressing the biological activity consists in coating the pressure-stable housing 44 of the module insert 4 with the above-mentioned substances. This pressure-stable housing 44 has an upper outer face 47 and side faces 48; such a substance can be applied to these outer faces 47 and 48 directly to suppress the biological activity. It is also possible to structure these faces 47 and 48 during the production process and then coat them.

The diamond pattern 91 shown in the figures is merely for illustration purposes. The structuring 91 of the faces 47 and 48 can be freely selected and is preferably three-dimensional or pyramidal.

The structuring of the inner wall 23 of the part 2a of the filter housing 2 and of the faces 47, 48 of the pressure-stable housing 44 increases the surface area thereof which can be used to suppress the biological activity by means of a suitable coating.

Further possibilities (not shown) of suppressing the biological activity are attaching a mini UV LED in the water collection chamber 43 together with a catalytically active surface consisting of platinum, titanium dioxide etc., which can be applied to the inner wall 23 of the filter housing 2. It can also simply be a metal plate which is placed in the water collection chamber 43, or the filter housing 2 itself if it is produced from metal. The mini UV LED could for example be accommodated in the water level sensor 42. It is sufficient for the mini UV LED to be switched on during driving, as fresh biological activity is reintroduced into the water collection chamber 43 only after filling the fuel tank. A slight AC voltage, as is used in the paper industry, prevailing in the water collection chamber 43 likewise prevents the growth of activated sludge.

Alternatively, starch capsule could be present in the water collection chamber 43, which releases the biocidal substances on contact with water and gradually dissolves; these would have to be replaced when the filter is changed, as new biological activity is brought constantly into the filter device by the reintroduction of fuel.

Other alternatives are also the coating of the inner wall 23 of the filter housing 2 with hydrophobic coatings with a signal effect or antifouling paint, which are known from shipbuilding.

FIG. 2 shows a view of a detail from FIG. 1, wherein the structures 92 present on the inner wall 23 are shown in detail. The exact shape can be selected freely, but a pyramid shape (not shown) is preferred.

FIG. 3 shows a plan view of the module insert 4. In order to be able to accommodate at least one water level sensor 42, the pressure-stable housing 44 differs from the circular shape. The module insert 4 can be fixed to the filter housing 2 by means of openings 71 in indentations 70, for example by means of screw fastenings. There is enough space in the region around the water level sensors in the water collection chamber 43 for the nonwoven fabric 90 to be accommodated there. As an alternative to the nonwoven fabric 90, structuring 91, as shown in FIG. 1 and FIG. 2, (not shown in FIG. 3) can be provided on the face 47 of the pressure-stable housing 44.

FIG. 4 shows an outer view of the module insert 4. It has a multi-part structure, wherein the base 73 is fixed to the pressure-stable housing 44, for example by means of screw fastenings 72 or the like. A seal 74 is used to seal off from the filter housing 2. The purified and now clean water is drained into the environment via an outlet 49. The structuring 91 applied to the side face 48 is only schematically drawn here.

No activated sludge forms in the water collection chamber thanks to the use of substances which suppress the biological activity. Although the water collection chamber 43 in the fuel filter according to the invention is very small, activated sludge could form if water remains in the water collection chamber 43 for a relatively long time. This is prevented by just small quantities of substances which suppress biological activity. This also prevents water which has been contaminated with biologically active microbes from passing into the module insert 4, the fine flow channels 63, 66, 69 of which would become clogged very quickly. Moreover, active carbon present in the container would promote the growth of biologically active microbes, so it is sensible to kill them beforehand. A comparatively small screen 64 retains these small quantities of biologically dead suspended matter.

FIG. 5 shows the interior of the module insert 4 along the section A-A from FIG. 3. The water which has separated out of the fuel and collected in the water collection chamber 43 takes the following path when the water level sensors 42 open the valves 65a and 65b, for example solenoid valves. The water first flows through the small screen 64 into the flow channel 63, in which further sensors 68 are situated. The two valves 65a and 65b are attached to the flow channel 63. A displacer element 67 lies in the flow channel 66 between the valves 65a and 65b, which displacer element is intended to prevent the water from freezing at this point; see in this respect DE 10 2007 054 770, which is hereby incorporated by reference. The water then passes via a flow channel 69 into a container 61 which is configured as a cleaning cartridge and therefore can be replaced. There can be different materials in the container 61, which absorb the remnants of fuel which are still contained in the drained water. Active carbon or a fuel-absorbing woven fabric, nonwoven fabric, textile, carpet or similar can be the absorbent material in the container 61. Even the material of the container 61 itself can be configured so that it swells due to the absorption of fuel and thus removes the remaining fuel from the separated water. The aim is that the separated water contains only approximately 2 ppm of fuel residue; this proportion is considered safe for the environment.

The module insert 4 is composed of the pressure-stable housing 44 and an inner part 45 in which the channels 63, 66 and 69 are arranged. The module insert 4 is closed from below with a base 76 which is connected fixedly to the inner part 45 and a lower lid 77 which makes it possible to change the container/cleaning cartridge 61. Alternatively, the lower lid 77 can also be connected fixedly, for example by welding, to the inner part 45 and to the pressure-stable housing 44.

The water-conducting flow channel 69 and the container 61 in the module insert 4 which are situated downstream of the solenoid valves 65a and 65b should idle as slowly as possible in order to improve the adsorption conditions in the container 61. Optimal adsorption conditions prevail at a certain flow of the separated water through the container 61; it preferably flows from bottom to top, alternatively it can flow from top to bottom, as shown here. The flow channels 63, 66, 69 necessary for this are provided as required in the inner part 45. The flow channel 69 downstream of the solenoid valves 65a/b is pressureless with air cushions, this volume reserve being used to absorb changes in volume, for example during freezing. The pressure-stable housing 44 is therefore also necessary to shield this region from the pressure in the fuel.

The free ventilation of the outlet 49 downstream of the container 61 with the active carbon filter means that the water can drain out of this region and any connected lines (not shown). A ventilation valve can also be present in the flow channel 69 upstream of the container 61 so that air can enter and the water drains out of the downstream container 61 and lines. This ventilation valve opens pressurelessly or when there is a vacuum and closes with pressure (not shown).

The further sensors 68 can be a temperature sensor and a heating system for thawing or operation at sub-zero temperatures; the use of the temperature sensor 68 and the associated signal processing should ensure that the solenoid valves 65 are not opened at sub-zero temperatures.

The module insert 4 has an integrated structure, that is, it contains all the lines for the water separated out of the fuel through the flow channels 63, 66 and 69 integrated in the inner part 45. The module insert 4 has the accommodating geometry for the solenoid valves 65, it integrates the container 61 with the absorber fixedly or replaceably, it has a connection to the power supply, it conducts currents and signals or has installation space for signal processing components. Furthermore, it accommodates the water level sensors 42 for the detection of water, which project into the water collection chamber 43 of the filter housing 2. The solenoid valves 65 are configured in such a manner that they are closed without current. The arrangement of the solenoid valves 65 is such that, at least in one solenoid valve, the fuel pressure pushes the valve closed, and the valve must open against the fuel pressure.

The module insert 4 has a three-part structure in order to facilitate its installation in the fuel filter housing 2. The water collection chamber 43 is formed by the free spaces between the module insert 4 and the filter housing 2. The pressure-stable housing 44 absorbs the forces due to the fuel pressure. The housing 44 can consist of aluminium or flame-resistant plastics and thereby ensures the tightness of the fuel system for a sufficiently long time, even in the event of a vehicle fire.

In the module insert 4 too, the surfaces of the inner part 45, for example the flow channels 63, 66, 69 which come into contact with the separated water can be provided with corresponding coatings. In particular, the active carbon in the container 61 should advantageously be doped with copper or silver or other biocidal substances should be used in the container 61. This prevents back-contamination of the filter device 1 via the outlet 49. As the outlet drains the water directly into the environment as required, contamination of the filter device can occur via the outlet. The screen 64, which is installed in the module insert 4 below the water level sensor 42 is used to filter suspended matter out of the separated water. The screen itself can also have a biocidal coating or consist of copper or silver.

Irradiation of at least parts of the filter device with gamma or beta radiation before packing them ready for dispatch is also conceivable, as a result of which prior contamination with biologically active material or organisms can be avoided.

1. A filter device comprising:
a liquid inlet and a liquid outlet, a filter housing, at least one filter element and at least one water collection chamber configured to collect water separated out of the fuel, and
a mechanism for suppressing biological activity disposed at least in the water collection chamber.

2. The filter device according to claim 1,
wherein the mechanism is configured to have at least one of an antibacterial, fungicidal and antibiotic effect.

3. The filter device according to claim 1,
wherein the mechanism contains metals including at least one of silver, monomers with a functional amino group, and oligomers with a functional amino group.

4. The filter device according to claim 1,
further comprising a fiber-based carrier material which is formed as at least one of a nonwoven, knitted fabric and a carpet, and to which is applied to the mechanism by coating methods.

5. The filter device according to claim 4,
wherein the carrier material has a structured surface.

6. The filter device according to claim 1,
further comprising an active carbon filter disposed downstream of the water collection chamber, wherein the active carbon filter is doped with at least one of copper and silver ions.

7. The filter device according to claim 1,
further comprising an absorber on an intake of which a copper screen is arranged at the at least one water collection chamber.

8. The filter device according to claim 1,
wherein the mechanism is configured as at least one of a current source and light source, the current source being an alternating current source and, the light source being a UV light source.

9. The filter device according to claim 1, wherein the filter device is disposed in an internal combustion engine.

10. (canceled)

11. The filter device according to claim 1, wherein the filter device is at least one of a fuel and lubricant filter.

12. The filter device according to claim 2, wherein the mechanism contains metals including at least one of silver, monomers with a functional amino group, and oligomers with a functional amino group.

13. The filter device according to claim 12, further comprising a fiber-based carrier material which is formed as at least one of a nonwoven, knitted fabric and carpet, and to which is applied to the mechanism by coating methods.

14. The filter device according to claim 13, wherein the carrier material is a flat carrier material including an antibiotic and an antibacterial coating having a structured surface.

15. The filter device according to claim 14, further comprising an active carbon filter disposed downstream of the water collection chamber, wherein the active carbon filter is doped with at least one of copper and silver ions.

16. The filter device according to claim 15, further comprising an absorber on an intake of which a copper screen is arranged at the at least one water collection chamber.

17. The filter device according to claim 16, wherein the mechanism is configured as at least one of a current source and a light source, the current source being an alternate current source and the light source being a UV light source.

18. The filter device according to claim 2, further comprising an active carbon filter disposed downstream of the water collection chamber.

19. The filter device according to claim 18, wherein the active carbon filter is doped with at least one of copper and silver ions.

20. The filter device according to claim 2, further comprising an absorber on an intake of which a copper screen is arranged at the at least one water collection chamber.

21. The filter device according to claim 2, wherein the mechanism is configured as at least one of a current source and light source, the current source being an alternate current source and the light source being a UV light source.
